(19) United States
(12) Patent Application Publication
(10) Pub. No.: US 2025/0282090 A1
(43) Pub. Date: Sep. 11, 2025

(54) STRETCHING UNIT AND FILM PRODUCTION SYSTEM

(71) Applicant: BRÜCKNER MASCHINENBAU GmbH, Siegsdorf (DE)

(72) Inventor: Anton WETTEMANN, Vachendorf (DE)

(21) Appl. No.: 19/075,015

(22) Filed: Mar. 10, 2025

(30) Foreign Application Priority Data
Mar. 11, 2024 (DE) 10 2024 106 937.6

(51) Int. Cl. B29C 55/08

(52) U.S. Cl. CPC B29C 55/08

(57) ABSTRACT

A stretching unit for stretching a film, in particular a transverse direction orienter and/or simultaneous stretching unit, including an oven and a heat recovery system is disclosed. The heat recovery system includes a heat exchanger with an exhaust air duct for exhaust air from the oven, a supply air duct for supply air to the oven, a plurality of heat conductors, a plurality of heat collectors and a condensate collector. The exhaust air duct is open towards the condensate collector, in which the heat collectors are located in the exhaust air duct with an interstice between adjacent heat collectors, and the heat conductors are connected thermally to the heat collectors, and in which the interstices are open towards the condensate collector.

### CROSS REFERENCE TO RELATED APPLICATION

This application claims priority to German Patent Application Number DE 10 2024 106 937.6, filed Mar. 11, 2024, the entire contents of which is hereby incorporated by reference.

### BACKGROUND

The disclosure relates to a stretching unit as well as a film production system.

Film production systems are known and usually comprise at least one stretching unit.

The production of plastic film in such systems is very energy-intensive as high temperatures are required in the ovens of the stretching units.

At that same time, fresh air must be fed to the oven continuously and in return exhaust air must be extracted in order to reduce contamination in the oven. Contamination occurs, among other things, as different kinds of substances, primarily hydrocarbons, escape from the film when passing through the oven. The air exchange here is related to high heating energy demands as the fresh air drawn in must be heated to the oven temperature.

It is thus known to provide film production systems with a heat exchanger for heat recovery. However, it is problematic in such systems that the substances contained in the oven air condense on the heat exchanger when cooling and precipitate on the exhaust-air side of the surface of the heat exchanger. Consequently, the efficiency of the heat exchanger deteriorates so that the heat exchanger must be cleaned laboriously.

### SUMMARY

It is provided a stretching unit and a film production system that is particularly energy-efficient and simultaneously low-maintenance.

A stretching unit for stretching a film, in particular transverse direction orienter and/or simultaneous stretching unit, is provided comprising an oven and a heat recovery system. The heat recovery system comprises a condensate collector and a heat exchanger with an exhaust air duct for exhaust air from the oven, a supply air duct for supply air to the oven, a plurality of heat conductors and a plurality of heat collectors. The supply air duct and the exhaust air duct are separated fluidly from each other by a partition, and the heat conductors extend from the exhaust air duct through the partition into the supply air duct, wherein the exhaust air duct is open towards the condensate collector. The heat collectors are located in the exhaust air duct with an interstice between adjacent heat collectors, and the heat conductors are connected thermally to the heat collectors, wherein the interstices are open towards the condensate collector.

A higher degree of efficiency of the heat exchanger is achieved by means of the heat collectors. At the same time, the precipitated condensate is transported away reliably through the condensate collector and as the interstices are open towards the condensate collector. Consequently, the high degree of efficiency also remains permanently high without cleaning and thus maintenance.

For example, each heat collector is connected thermally to at least one, multiple or all of the heat conductors.

The supply air is, in particular, fresh air from the environment of the stretching unit.

In an embodiment, multiple heat emitters that are designed like the heat collectors are provided in the supply air duct.

In an embodiment, the exhaust air duct defines a flow path for the air flow of the exhaust air, wherein the condensate collector is located outside of the flow path. In this way, it avoids the condensate being carried from the heat exchanger by the air flow.

For a further improved removal of the condensate from the interstices, the condensate collector can be arranged at least in part below the exhaust air duct, in particular below the flow path.

Within the scope of this disclosure, the term “below” is understood to mean in relation to the provided assembly position of the heat recovery system. In particular, “below” is to mean directly vertically below and not additionally horizontally offset.

In an embodiment, the exhaust air duct comprises a condensate outlet opening that is part of the condensate collector, in particular wherein the exhaust air duct comprises a base and said at least one condensate outlet opening is provided in the base. In this way, the collected condensate can be removed reliably from the exhaust air duct.

For example, the base is designed level or as a channel.

In an embodiment, the condensate collector comprises a tray, in particular wherein the tray is removeable from the condensate collector for emptying. As a result, the condensate can be collected reliably and, in particular, disposed of simply.

To reduce maintenance further, the heat recovery system can comprise a condensate drain and the condensate collector is connected fluidly to the condensate drain, in particular by means of a siphon.

To improve the efficiency of the heat exchanger further, the heat collectors can be designed plate-shaped and the heat conductors can extend through the heat collectors.

For example, each heat conductor extends through at least one, multiple or all heat collectors, in particular perpendicularly.

In an embodiment, the heat collectors run parallel to each other and/or parallel to the partition in order to reduce flow resistance.

To drain away any condensate at the collectors reliably, the heat conductors can run horizontally or be arranged at an angle of between 0° and 10° to the horizontal direction, in particular wherein the section of the heat conductor in the exhaust air duct is situated lower than that section in the supply air duct.

For example, the angle is 4°.

In an embodiment, the interstices comprise a direction of air flow and a direction of condensate flow, wherein the direction of air flow and the direction of condensate flow run parallel to each other, in particular wherein the direction of air flow and the direction of condensate flow run vertically or are orientated at an angle of between 0° and 10° to the vertical. In this way, the removal of the condensate from the interstices is supported by the air flow.

The direction of condensate flow is, for example, that direction in which the condensate formed at the heat collectors can flow unimpeded—except for the heat conductors. The direction of condensate flow runs in particular downwards.

The heat conductors can extend in the region of the heat collectors perpendicular to the direction of air flow and/or the direction of condensate flow.

In an embodiment, the interstices comprise a direction of air flow and a direction of condensate flow, wherein the direction of air flow and the direction of condensate flow run perpendicular to each other, in particular wherein the direction of air flow runs horizontally and/or the direction of condensate flow runs vertically or is orientated at an angle of between 0° and 10° to the vertical. In this way, the amount of condensate being transported into the environment through the air flow is reduced further.

To increase efficiency further, the heat conductors can be heat-transfer devices, in particular heat pipes.

In an embodiment, the oven comprises a supply air inlet which is connected fluidly to the supply air duct of the heat exchanger, and/or the oven comprises an exhaust air outlet that is connected fluidly to the exhaust air duct of the heat exchanger so that a direct and efficient connection of the heat recovery system to the oven is achieved.

The fluid connection occurs, for example, by means of piping.

To temperature control the supply air, the heat recovery system can comprise a heating register. For example, the heating register can be arranged fluidly between the supply air duct of the heat exchanger and the supply air inlet of the oven.

The supply air fan is located, for example, between the supply air duct of the heat exchanger and/or of the heating register and the supply air inlet of the oven. The exhaust air fan is located, for example, downstream of the exhaust air duct of the heat exchanger.

There is also provided a production system comprising at least one stretching unit as described previously as well as one further stretching unit, an extrusion unit, a cast rolling system, a draw roller unit and/or a winder unit.

The features and advantages described for the stretching unit apply equally to the film production system and vice versa.

### BRIEF DESCRIPTION OF THE DRAWINGS

Additional features and advantages of the disclosure are found in the following description as well as the attached drawings to which reference is made. In the drawings:

FIG. 1 shows a film production system according to an embodiment of the disclosure comprising at least a stretching unit according to an embodiment of the disclosure in a schematic, perspective view,

FIG. 2 shows an enlarged representation of a heat recovery system of the stretching unit according to FIG. 1,

FIGS. 3, 4 show schematic sectional views through the heat exchanger of the heat recovery system according to FIG. 2,

FIG. 5 shows a perspective view of a heat exchanger of a stretching unit according to a second embodiment of the disclosure, and

FIG. 6 shows a sectional view through the heat exchanger of a heat recovery system of a stretching unit according to a third embodiment of the disclosure.

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

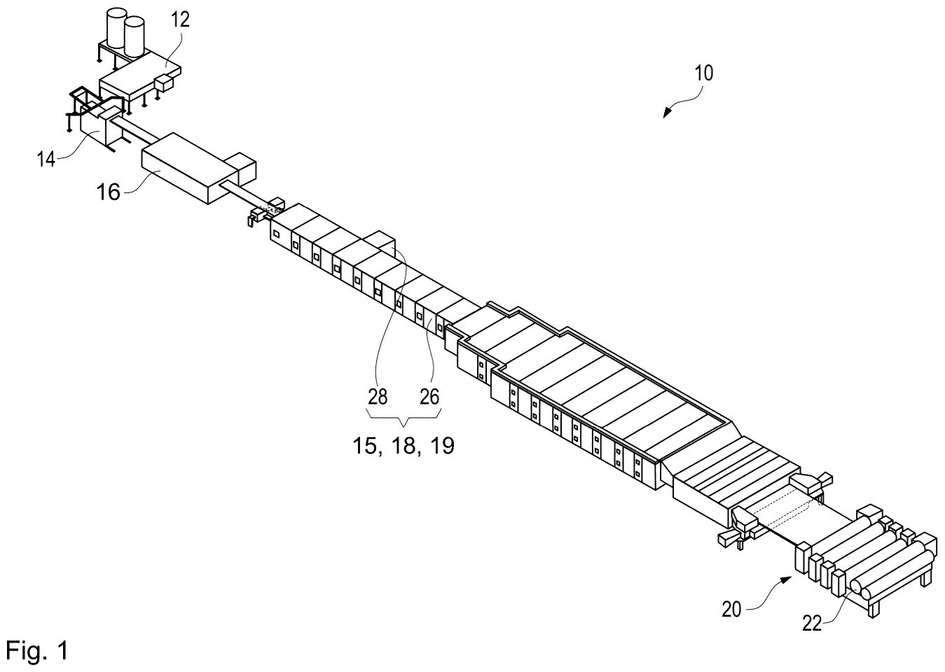

In FIG. 1, a film production system 10 is shown extremely schematically, which comprises several different units and devices.

In the shown example, the film production system 10 comprises an extrusion unit 12, a cast rolling system 14, at least one stretching unit 15—such as a machine direction orienter 16 (MDO) or a transverse direction orienter 18 (TDO)—, a draw roller unit 20 as well as a winder unit 22.

The film produced is, for example, a biaxially stretched film, such as polypropylene film (BOPP), PP capacitor film (BOPP-C), polyethylene terephthalate film (BOPET), polyamide film (BOPA), polyethylene film (BOPE) or polylactic acid film (BOPLA).

To produce plastic films, a film is created on the chill roll of a cast rolling system 14 by means of an extrusion unit 12. To this end, the extrusion unit 12 generates a melt from the starting products, such as granular material, said melt being applied to the chill roll, thereby creating the film.

This film is conveyed from the cast rolling system 14 to the machine direction orienter 16. In the machine direction orienter 16, the film is stretched in the machine direction in order to obtain a stretched film.

In the machine direction orienter 16, the film runs over a plurality of rollers that are heated in order heat the film to the desired temperature so that it can be stretched.

Between at least two of the rollers present in the machine direction orienter 16, the stretching takes place in the machine direction, i.e. in the drawing direction, so that the film becomes a stretched film.

The film obtained is conveyed by the machine direction orienter 16 to the transverse direction orienter 18 and stretched in the transverse direction orienter 18 in the transverse direction.

Along the drawing direction of the film production system 10, the transverse direction orienter 18 has an oven 26 comprising different zones for treating the film.

The film is heated in the first zone, also termed the preheating zone. In the subsequent second zone (“stretching zone”), the film is stretched in the transverse direction so that its width is greater and its thickness is less at the end of the second zone than it was at the start.

After completing the stretching, the film then passes through the third and further zones (termed “heat treatment zone”, “further heating zone” and/or “annealing zone”), in which a relaxation of the film, for example, can take place at high temperatures.

Subsequently, the film passes through a further zone (“cooling zone”), whereby the film is cooled in the last zone.

A further zone is termed the neutral zone and serves to separate the zones. The neutral zone is, for example, an empty space without any ventilation.

The zones of the transverse direction orienter 18 can also be divided differently and/or designed in their lengths differently. For example, fewer or shorter neutral zones can be provided or the neutral zones can be arranged at other points, also additionally. Changes in the remaining zones are also conceivable.

After the transverse direction orienter 18, the now biaxially stretched film runs through the draw roller unit 20 and is wound by means of the winder unit 22.

It is also conceivable that the film production system 10 is designed in another way, for example comprising a simultaneous stretching unit 19 with an oven 26 as a stretching unit 15 alternatively or in addition to the machine direction orienter 16 and/or to the transverse direction orienter 18.

Within the scope of this disclosure, a stretching unit 15 is now described in general that can both be a transverse direction orienter or simultaneous stretching unit or a combination of these.

The stretching unit 15, more specifically its oven 26, continually requires supply air, particularly fresh air, during operation in order to be capable of extracting contaminated exhaust air in return.

To be capable of using the exhaust heat from the exhaust air, the stretching unit 15 comprises a heat recovery system 28.

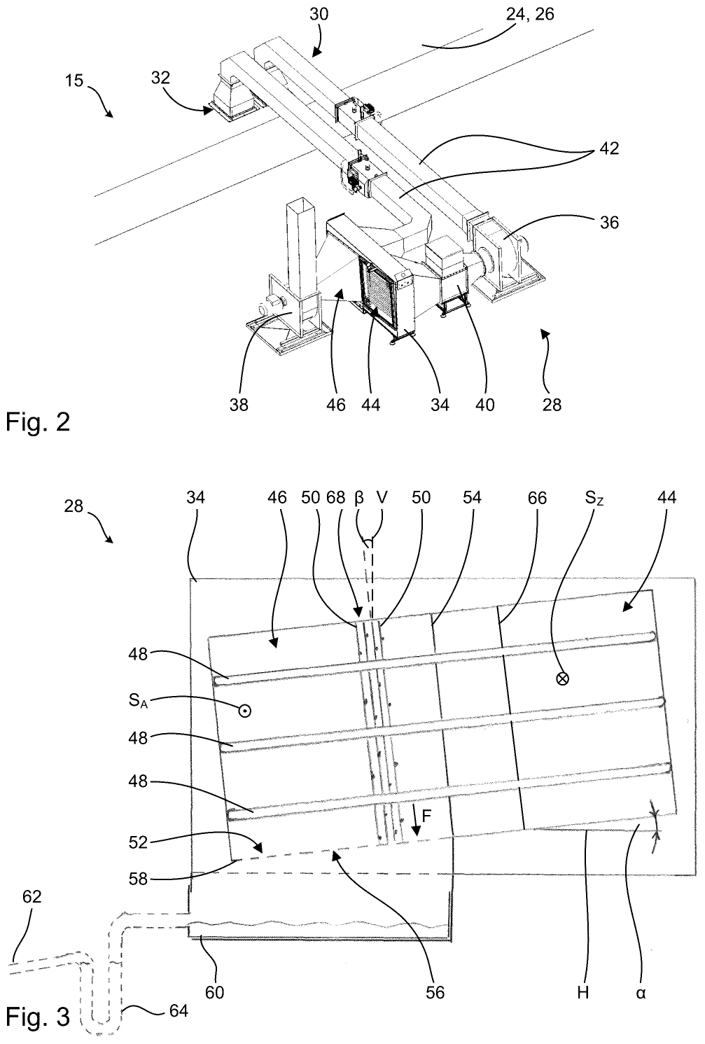

In FIG. 2, one of the heat recovery systems 28 is enlarged, of which a stretching unit 15 can also comprise several ones.

It can be seen that the oven 26 comprises a supply air inlet 30 and a exhaust air outlet 32, which are both connected fluidly to the heat recovery system 28.

The heat recovery system 28 comprises a heat exchanger 34, a supply air fan 36, a exhaust air fan 38, a heating register 40, piping 42 as well as a condensate collector 52.

The heat exchanger 34 has a supply air duct 44 as well as an exhaust air duct 46 that are fluidly separate from each other and each have a fluid connection to the supply air inlet 30 or the exhaust air outlet 32, respectively, of the oven 26 by means of the piping 44.

The supply air duct 44 of the heat exchanger 34 is open upstream in relation to the supply air flow towards the environment of the oven 26 and the heat recovery system 28. Optionally, an air filter is provided on this side.

Downstream, the supply air duct 44 of the heat exchanger 34 is connected fluidly to the heating register 40 and the supply air fan 36, which are arranged between the supply air duct 44 and the supply air inlet 30. For example, the supply air fan 36 is arranged downstream of the heating register 40 so that the heating register 40 is located between the heat exchanger 34 and the supply air fan 36.

The exhaust air fan 38 can be located, in relation to the exhaust air flow, downstream of the exhaust air duct 46 of the heat exchanger 34 so that the heat exchanger 34 is located fluidly between the exhaust air fan 38 and the exhaust air outlet 32 of the oven 26.

It is also conceivable that the exhaust air fan 38 is located between the exhaust air outlet 32 and the heat exchanger 34.

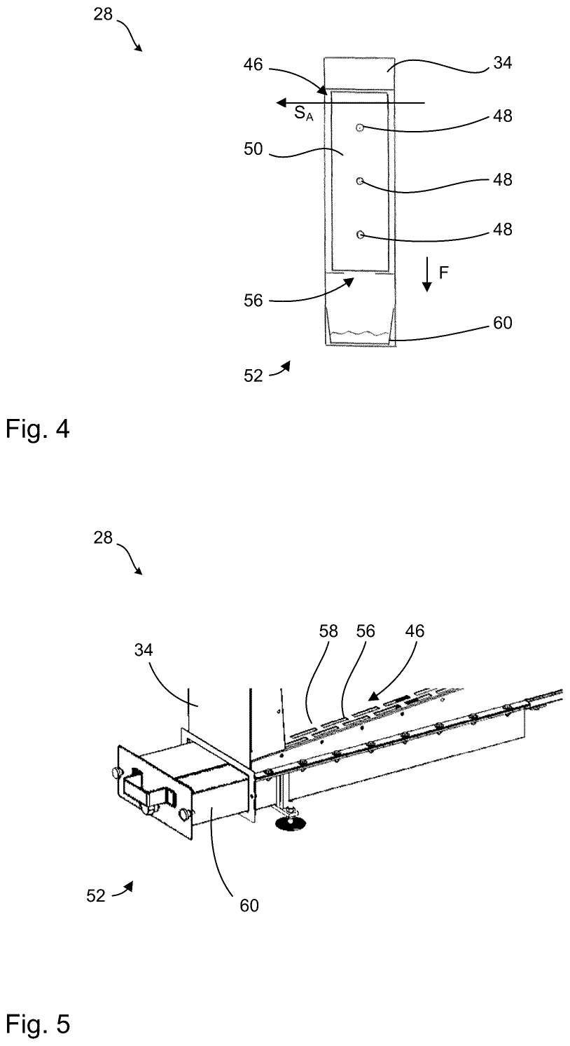

In FIGS. 3 and 4, the heat exchanger 34 of the heat recovery system 28 is shown simplified in the longitudinal view and in the cross section (each orthogonally to the direction of flow).

In addition to the supply air duct 44 and the exhaust air duct 46, the heat exchanger 34 comprises a plurality of heat conductors 48, a plurality of heat collectors 50 as well as a partition 54.

For the sake of clarity, only a few heat conductors 48 and a few heat collectors 50 are shown in the figures in order to explain the basic principle. It is conceivable that considerably more heat conductors 48 and/or heat collectors 50 are provided.

In FIGS. 3 and 4, the heat exchanger 34 is shown in the provided assembly position so that parts shown below in relation to gravity are also arranged below in the figures.

In the heat exchanger 34, the supply air duct 44 and the exhaust air duct 46 are located directly adjacent to each other. The supply air duct 44 is separated fluidly from the exhaust air duct 46 by means of a partition 54.

The exhaust air duct 46 defines a flow path for the air flow S_{A} of the exhaust air. The direction of air flow S_{A} of the exhaust air in the exhaust air duct 46 and the direction of air flow S_{Z} of the supply air in the supply air duct 44 run antiparallel to each other. It is conceivable that the direction of air flow S_{A} of the exhaust air in the exhaust air duct 46 and the direction of air flow S_{Z} of the supply air in the supply air duct 44 run parallel to each other.

In the first embodiment, the direction of air flow S_{A} in the exhaust air duct 46 and the direction of air flow S_{Z} of the supply air duct 44 run horizontally.

The condensate collector 52 is located below the exhaust air duct 46, and the exhaust air duct 46 is open towards the condensate collector 52. The condensate collector 52 is located outside, in particular below the flow path.

The condensate collector 52 can be realised at least in part, in particular completely, through condensate outflow openings 56 that are provided in the base 58 of the exhaust air duct 46. The base 58 can be designed here as a channel.

Below means in this regard in particular that at least parts of the condensate collector 52 or the entire condensate collector 52 is located directly vertically below at least parts of the exhaust air duct 46 or the entire exhaust air duct 46, i.e. following the force of gravity.

The condensate collector 52 comprises in addition a tray 60 that is located, for example, below the condensate outflow openings 56. To drain the tray 60, the heat recovery system 28 can comprise a condensate drain 62, as shown in FIG. 3 with dashed lines. The condensate drain 62 is connected fluidly to the condensate collector 52, in FIG. 3 to the tray 60, for example by means of a siphon 64.

The heat conductors 48 are designed as heat-transfer devices, for example, in particular as heat pipes.

The heat conductors 48 are each located in part in the supply air duct 44 and in part in the exhaust air duct 46. Thus, they extend from the exhaust air duct 46 through the partition 54 into the supply air duct 44. In relation to the directions of air flow S_{A} and S_{Z}, the heat conductors 48 run perpendicularly.

The heat conductors 48 can run in the horizontal direction H or, as shown in FIG. 3, at an angle α to the horizontal direction H of 0° to 10°. For example, the angle is 4°. Here, the heat conductors 48 ascend towards the supply air duct 44 so that the section of each heat conductor 48 in the exhaust air duct 46 is situated lower than the section of the same heat conductor 48 in the supply air duct 44.

The heat collectors 50 are located in the exhaust air duct 46 and designed plate-shaped in the shown embodiment. They are arranged parallel to each other and run, for example, parallel to the partition 54.

The heat collectors 50 extend in the direction of air flow S_{A} as well as in the vertical direction V or at an angle β of between 0° and 10° to the vertical direction V.

The heat collectors 50 extend perpendicular to the heat conductors 48, wherein they are connected thermally to one, multiple or all heat conductors 48. One, multiple or all heat conductors extend, for example, through one of the heat collectors 50 and are connected to it thermally.

Similarly, each of the heat conductors 48 are connected thermally to one, multiple or all heat collectors 50.

In the same way as the heat collectors 50, a plurality of heat emitters 66 are provided in the supply air duct 44, wherein only one of the heat emitters 66 is shown in FIG. 3 for the sake of clarity.

The heat collectors 50 are located parallel to each other so that an interstice 68 is formed in each case between two adjacent heat collectors 50. The interstices 68 thus run in the same directions as the heat collectors 50.

The interstices 68 are open in the direction of air flow S_{A} as a result of the arrangement of the heat collectors. Thus, the direction of air flow S_{A}, in which the exhaust air flows into the interstices 68, can also be allocated to the interstices 68.

Similarly, the interstices 68 are open towards the condensate collector 52, i.e. downwards.

The interstices 68 comprise a direction of condensate flow F that describes that direction in which the condensate precipitating from the exhaust air on the heat collectors 50 flows off. The direction of condensate flow F runs, for example, downwards and has a component directed primarily downwards, i.e. in the direction of gravity.

The interstices 68 also extend like the heat collectors 50 in the vertical direction V or at the angle β to the vertical direction V. In the example of FIG. 3, the heat conductors 48 extend perpendicular to the direction of condensate flow F.

In the example according to FIG. 3, the direction of condensate flow F runs perpendicular to the direction of air flow S_{A}.

During the operation of the film production system 10 and the stretching unit 15 and thus also the heat recovery system 28, warm air is conveyed from the oven 26 through the exhaust air duct 46 by means of the exhaust air fan 38.

This exhaust air contains, for example, hydrocarbons that condense rapidly when cooling.

The warm exhaust air thus flows through the exhaust air duct 46 of the heat exchanger 34 in the direction of air flow S_{A} and there, comes into contact with the heat collectors 50 and the heat conductors 48. Subsequently, the exhaust air is transported through the exhaust air fan 38 into the environment of the stretching unit 15.

In the exhaust air duct 46, the exhaust air transfers heat to the heat collectors 50, which are colder in comparison to the exhaust air, and the heat conductors 48.

This emitted heat is transported through the heat collectors 50 and then through the heat conductors 48 into the supply air duct 44.

Supply air, in particular fresh air, conveyed by means of the supply air fan 36 flows through the supply air duct 44.

In the supply air duct 44, the supply air is heated due to contact to the heat conductors 48 and the heat emitters 66 that are warmer than compared to the supply air. Subsequently, the supply air passes the heating register 40 and is heated to the temperature required in the oven until it enters the oven 26 through the supply air inlet 30.

In the exhaust air duct 46, as described, the exhaust air is cooled at the heat collectors 50. The hydrocarbons found in the air condense as a result of this cooling and form a condensate on the heat collectors 50 and the heat conductors 48.

Owing to the arrangement of the heat collectors 50 and the interstices 68, the condensate can flow downwards, i.e. in the direction of condensate flow F, without any impediment—except for the traversing heat conductors 48.

As soon as the condensate reaches the lower end of the heat collectors 50, it can drain or flow away from the heat collectors 50 and is collected by the condensate collector 52. Subsequently, the condensate can be disposed of through the condensate drain 62.

In this way, it ensures that no condensate remains in the exhaust air duct 46 and specifically in the interstices 68 and that these can be clogged. In this way, a very good degree of efficiency of the heat exchanger 34 is ensured without complex maintenance activities being necessary.

The heat recovery system 28 is thus extremely efficient and at the same low-maintenance.

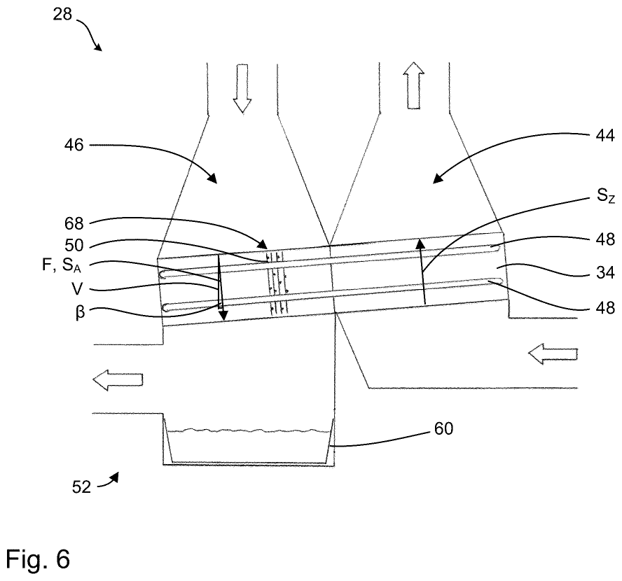

In FIGS. 5 and 6, further embodiments of the heat recovery system 28 and thus the stretching unit 15 and the film production system 10 are shown. These correspond substantially to the first embodiment so that only the differences are discussed hereinafter and the same and functionally equivalent parts are provided with the same reference signs.

FIG. 5 shows a perspective view of a part of a second embodiment of a heat exchanger 34.

In this embodiment, the tray 60 of the condensate collector 52 can be removed, i.e. removed from below the exhaust air duct 46. In this way, the tray 60 can be emptied easily without needing to provide a dedicated condensate drain 62.

In FIG. 5, the condensate outflow openings 56 are also clearly evident in the base 58 of the exhaust air duct 46.

For example, the condensate outflow openings 56 are provided on the downstream edge of the base 58 so that the air flow S_{A} conveys the condensate drained on the base to the condensate outflow openings 56.

In FIG. 6, a third embodiment of the heat recovery system 28 is shown.

In this embodiment, the direction of air flow S_{A}, S_{Z} of the exhaust air or the supply air do not run horizontally, but vertically towards the heat collectors 50 and the heat conductors 48.

Below the heat collectors 50 and the heat conductors 48, the exhaust air duct 46 runs horizontally and/or offset from the heat exchanger 34 so that the flow path also accordingly changes direction (indicated by arrows in FIG. 6).

The condensate collector 52 is located below the site at which the flow path carries out the change in direction.

The condensate collector can be designed as described for the previous embodiments.

The arrangement of the heat collectors 50 and the heat conductors 48 in the supply air duct 44 correspond to the arrangement in the first embodiment so that the interstices 68 are still open towards the condensate collector 52.

In this embodiment, the direction of air flow S_{A} and the direction of condensate flow F now run parallel to each other within the region of the heat collectors 50.

The direction of air flow S_{A} and the direction of condensate flow F run in the vertical direction V or, as shown, at an angle β of between 0° and 10° to the vertical direction V.

The removal of condensate from the interstices 68 is improved in this embodiment as 10 the direction of air flow S_{A} and the direction of condensate flow F run in a parallel manner.

The different features of various embodiments are combinable with each other, in particular the use of a removeable tray 60, a condensate drain 62 and/or the position of the condensate outflow openings 56 in the base 58.

1. A stretching unit for stretching a film, comprising:
an oven and a heat recovery system,
wherein the heat recovery system comprises a condensate collector and a heat exchanger with an exhaust air duct for exhaust air from the oven, a supply air duct for supply air to the oven, a plurality of heat conductors and a plurality of heat collectors,
wherein the supply air duct and the exhaust air duct are separated fluidly from each other by a partition, and the heat conductors extend from the exhaust air duct through the partition into the supply air duct,
wherein the exhaust air duct is open towards the condensate collector, and
wherein the heat collectors are located in the exhaust air duct with an interstice between adjacent heat collectors, and the heat conductors are connected thermally to the heat collectors, wherein the interstices are open towards the condensate collector.

2. The stretching unit according to claim 1, wherein the exhaust air duct defines a flow path for the air flow of the exhaust air, wherein the condensate collector is located outside of the flow path.

3. The stretching unit according to claim 1, wherein the condensate collector is located at least in part below the exhaust air duct.

4. The stretching unit according to claim 1, wherein the condensate collector is located at least in part below the flow path.

5. The stretching unit according to claim 1, wherein the exhaust air duct comprises a condensate outlet opening that is part of the condensate collector.

6. The stretching unit according to claim 1, wherein the condensate collector comprises a tray.

7. The stretching unit according to claim 1, wherein the heat recovery system comprises a condensate drain and the condensate collector is connected fluidly to the condensate drain.

8. The stretching unit according to claim 1, wherein the heat collectors are plate-shaped and the heat conductors extend through the heat collectors.

9. The stretching unit according to claim 1, wherein the heat collectors run at least one of parallel to each other or parallel to the partition.

10. The stretching unit according to claim 1, wherein the heat conductors run horizontally or are arranged at an angle of between 0° and 10° to the horizontal direction.

11. The stretching unit according to claim 10, wherein the section of the heat conductor in the exhaust air duct is situated lower than that section in the supply air duct.

12. The stretching unit according to claim 1, wherein the interstices comprise a direction of air flow and a direction of condensate flow, wherein the direction of air flow and the direction of condensate flow run parallel to each other.

13. The stretching unit according to claim 12, wherein the direction of air flow and the direction of condensate flow run vertically or are arranged at an angle of between 0° and 10° to the vertical direction.

14. The stretching unit according to claim 1, wherein the interstices comprise a direction of air flow and a direction of condensate flow, wherein the direction of air flow and the direction of condensate flow run perpendicular to each other.

15. The stretching unit according to claim 14, wherein at least one of the direction of air flow runs horizontally or the direction of condensate flow runs vertically or is arranged at an angle of between 0° and 10° to the vertical direction.

16. The stretching unit according to claim 1, wherein the heat conductors are heat-transfer devices.

17. The stretching unit according to claim 1, wherein the oven comprises at least one of a supply air inlet which is connected fluidly to the supply air duct of the heat exchanger or an exhaust air outlet that is connected fluidly to the exhaust air duct of the heat exchanger.

18. The stretching unit according to claim 1, wherein the heat recovery system comprises a heating register.

19. The stretching unit according to claim 18, wherein the heating register is arranged fluidly between the supply air duct of the heat exchanger and the supply air inlet of the oven.

20. A film production system comprising at least one stretching unit as well as at least one of a further stretching unit, an extrusion unit, a cast rolling system, a draw roller unit or a winder unit,
wherein the stretching unit comprises an oven and a heat recovery system,
wherein the heat recovery system comprises a condensate collector and a heat exchanger with an exhaust air duct for exhaust air from the oven, a supply air duct for supply air to the oven, a plurality of heat conductors and a plurality of heat collectors,
wherein the supply air duct and the exhaust air duct are separated fluidly from each other by a partition, and the heat conductors extend from the exhaust air duct through the partition into the supply air duct,
wherein the exhaust air duct is open towards the condensate collector, and
wherein the heat collectors are located in the exhaust air duct with an interstice between adjacent heat collectors, and the heat conductors are connected thermally to the heat collectors, wherein the interstices are open towards the condensate collector.
